(19) United States
(12) Patent Application Publication
(10) Pub. No.: US 2023/0297897 A1
(43) Pub. Date: Sep. 21, 2023

(54) DECENTRALIZED PARKING MANAGEMENT SYSTEM

(71) Applicant: Scientia Potentia Est ll, LLC, Charleston, SC (US)

(72) Inventors: Jeremy Blackburn, Charleston, SC (US); Justin Southward, Fort Meyers, FL (US); W. Kurt Taylor, N. Charleston, SC (US); Karl David, Charleston, SC (US); Austi Critchfield, Clearwater, FL (US); Michael Lu, N. Charleston, SC (US); Tim McVicker, Charleston, SC (US)

(73) Assignee: Scientia Potentia Est ll, LLC, Charleston, SC (US)

(21) Appl. No.: 17/697,839

(22) Filed: Mar. 17, 2022

(51) Int. Cl. G06Q 10/02; G06Q 20/26; G06Q 20/40; G06Q 50/30

(52) U.S. Cl. CPC G06Q 10/02; G06Q 20/26; G06Q 20/405; G06Q 50/30

(57) ABSTRACT

A system for dynamic allocation for vehicle parking that can include a server, geofence area representing a physical parking spot disposed in a physical parking area where the geofence is verifiably paired with the physical parking area. The server can be configured for receiving or capturing location and visual information from a remote computer device, associating the location information with the physical parking spot according to a comparison of the location information with the geofence area record, determining the vehicle identification according to the visual information, associating the vehicle identification with the user record, and actuating a debit of the financial account associated with the user.

### RELATED APPLICATIONS

This application is a continuation in part of U.S. patent application Ser. No. 17/686,502 filed Mar. 4, 2022 which in turn is a continuation in part of U.S. patent application Ser. No. 17/566,957 filed Dec. 31, 2021 which is in turn a continuation in part of U.S. patent application Ser. No. 17/561,827 filed Dec. 24, 2021 which is in turn a continuation in part of U.S. application Ser. No. 17/531,746 filed Nov. 20, 2021 which is in turn a continuation in part of U.S. application Ser. No. 17/531,598 filed Nov. 19, 2021 which in turn is a continuation in part of U.S. application Ser. No. 17/344,043 filed Jun. 10, 2021 which in turn is a continuation in part of U.S. application Ser. No. 17/230,911 filed Apr. 14, 2021 which in turn is a continuation in part of U.S. application Ser. No. 17/176,056 filed Feb. 15, 2021 which in turn is a continuation in part of U.S. application Ser. No. 17/128,084 filed Dec. 19, 2020 which in turn is a continuation in part of U.S. application Ser. No. 16/997,840 filed Aug. 19, 2020, which is a continuation in part of U.S. application Ser. No. 16/994,585 filed Aug. 15, 2020 (now U.S. patent Ser. No. 11/232,652 issued Jan. 25, 2022) which in turn is a continuation in part of U.S. patent application Ser. No. 16/991,916 filed on Aug. 12, 2020 (now U.S. patent Ser. No. 11/216,823 issued Jan. 4, 2022) which in turn is a continuation in part of U.S. patent application Ser. No. 16/876,080 filed May 17, 2020 which in turn is a continuation in part of U.S. patent application Ser. No. 16/810,782 filed on Mar. 5, 2020 (now U.S. patent Ser. No. 11/216,781 issued Jan. 4, 2022) which in turn is a continuation in part of U.S. patent application Ser. No. 16/510,634 filed on Jul. 12, 2019 (now U.S. Pat. No. 10,713,737 issued Jul. 14, 2020) and U.S. patent application Ser. No. 16/510,642 filed on Jul. 12, 2019 (now U.S. patent Ser. No. 11/216,772 issued Jan. 4, 2022), which are all incorporated by reference. Patent application Ser. Nos. 16/510,542 and 16/510,634 are both continuations of U.S. patent application Ser. No. 16/452,076 filed Jun. 25, 2019, which all are incorporated by reference.

### BACKGROUND

### 1) Field of the System

A system for auditing the capturing and storage of digital information representing the use of parking spots by vehicles which can be immutably stored digital information, paired digital representations with physical object, verifiable link between a physical object and a virtual representation and digital representations of parking spots, vehicles, and users, including transactions and events.

### 2) Background

With the increasing use of technology, all industries face risk and challenges including the use of digital technologies with physical object, locations and assets. This is especially true with the increased use of digital technologies such as paperless transactions, financial institution systems, property ownership records, crypto-currencies and the like. This has led to an increased focus on system that are designed to manage governmental, risk, audit, and compliance (GRC). For example, with the increased use of electric vehicles and autonomous vehicles, U.S. Pat. No. 10,286,903 discloses, a “method (and corresponding parking facility management server, parking system, and computer program) for carrying out an automatic parking process of a vehicle includes a reservation request for a parking position of a parking facility being sent to a parking facility management server via a communication network, navigation data for an autonomous navigation to the reserved parking position corresponding to the reservation request being received by the vehicle via the communication network, and the vehicle autonomously navigating in the parking facility to the reserved parking position based on the navigation data.” However, this disclosure requires the vehicle itself to receive navigation data for a reserved parking position and to vehicle autonomously navigating in the parking facility to the reserved parking position based on the navigation data. Therefore, this system is not suited for traditional vehicles.

There have been some attempts to improve the physical parking process such as stated in U.S. Pat. No. 11,1113,968 which discloses sending the position of a vacant parking area to a navigation apparatus of the vehicle. This reference also requires that the vehicle has a system that uses a radio key of the vehicle being placed onto a smartphone display, so that a lens in the vehicle key captures a flashing code and the radio key returns the flashing codes to the vehicle by radio. Again, a very specific and limited system, especially when use with traditional vehicles is desired.

Other attempts to assist with the parking process require that specialized hardware be installed and used at the parking location. United States Patent Application Publication 2013/0325564 discloses a system that includes a RFID reader placed from one side of the parking space; a camera installed in the parking space, wherein the camera is used to capture license plate information of parking cars; a first RFID tag placed from another side of the parking space; a second RFID tag placed in a car. Such systems are prone to hardware failures, have maintenance, service and repair costs and can be limited by the geography and environment surrounding the parking area. What would be desirable would be a parking management system that did not have the disadvantages of these references and the prior art.

Further, when using digital information, there is a disconnect with matching or paring the digital representation of the vehicle, user and parking spot with the actual physical object. Historical, digitization focused on creating a digital representation of a physical object so that the digital information can be manipulated by information systems and stored on a database. For example, a bank balance can be the digital representation of the fiat currency that is in the possession of the bank account holder. While these systems are sufficient for fungible objects such as currency, there is a challenge when the object is not fungible and needs to be tracked such as with vehicles and parking spots. Traditional methods of tracking objects such as UPC and other barcodes are not sufficient when applied to vehicles and parking spots. The UPC, for example, does not necessarily capture that a certain vehicle is in a certain spot.

Using existing technology taken from industries such as the financial industry does not solve the problem as they cannot verifiably pair a digital representation with a physical object for use in parking spot management applications. In the financial industry, digitization begins with electronic information representing the dollar value of an account and not a specific physical dollar itself. As the financial industry progressed, the electronic currency itself became the asset as discussed in U.S. Pat. No. 9,135,787, this patent discloses a Bitcoin kiosk/ATM that facilitates the buying or selling of Bitcoin. The underlying technology for Bitcoin is a blockchain. Blockchain alone cannot verifiably pair a digital representation with a physical object because there is no linkage between the physical object and the digital asset under the Bitcoin scheme alone. Blockchain provides an immutable data stream, or temporarily linear sequence of confirmed and verified data, rather than the ability to pair physical objects with digital representation.

Another disadvantage of blockchain is that the inability to verify transactions is generally limited to miners wherein the mining process is essentially the verification of a transaction. A transaction is the verification of preceding data blocks as well as confirmation of the current block. There have been some attempts to create verification systems, but none has proven to have sufficient accuracy needed for commercialization of these systems. For example, U.S. Pat. No. 10,790,963 uses a pattern count calculator that calculates the number of transaction patterns for a generating party using the blockchain generation apparatus. This requires that an identifier of the generating party is used with a block generation condition checker to determine whether the generating party is qualified to generate the new blockchain data.

This type of digitization where the digital information represents the asset that is to be distinguished with electronic scanning of a physical assets. Electronic scanning simply creates a digital copy that is separate from the physical object and becomes an independent object itself. Further, traditional scanners are not readably available at parking spot areas. The inability to pair the digital representation with physical object makes traditional digitization of physical objects challenging as the digital object and the virtual representation are not functional equivalents and therefore are not verifiably paired.

The ability to track object during a process can be improved when the object is properly and verifiable paired with a digital representation. In many industries, the systematic and logical workflow of physical objects increases the success of any project, process, activity, or providing a service. There is also a need to verify existing transactions that are stored on a blockchain or another immutable ledger. Currently, there is a lack of accountability, verification and reliability between physical objects and digital representations. The inability to verify the pairing of physical objects with digital representations negatively impacts current processes, increases risks, and increases costs in general. While there have been some attempts to add item information to a physical material, such as U.S. Pat. No. 8,321,302, these attempts have focused on tracking inventory levels and do not include verifiably pairing a physical object with a virtual representation. Further, these prior attempts focus on the identifier and not the physical object itself. Therefore, there is no assurance that the identifier remains associated with the physical object nor the ability to verify that it remains associated after the initial storage. This disadvantage can be seen in U.S. Pat. No. 8,521,620 which specifically states that if a RFID tag is lost or damaged, the system allows a user to enter an item number or style and tags of similar items are displayed, a new tag is generated and associated with the item having the lost or damaged tag. The ability to change RFID tags expressly shows that the physical object is not paired with the digital representation.

There have also been attempts to use inspections to assist with monitoring physical objects during a process. There have been attempts to provide for automated inspection such as U.S. Pat. No. 7,508,973 which discloses method of inspecting detects includes assigning a plurality of sets of image acquisition conditions, executing inspection using each of the sets of conditions, classifying all detected defects into real defects and false defects by use of an automatic defect classification function, and selecting, from the plurality of sets of conditions, a set of conditions ideal for detection. However, this attempt is reduced to a snapshot in time in the products lifecycle. This attempt does not pair the physical object to a digital representation, nor does it provide for an audit trail throughout the process.

There have been some attempts to improve tracking of articles such as shown in U.S. Pat. No. 7,898,403 that are directed to a method and system for detecting construction equipment process failures. These systems do not verify the data stored and associated with the life of a project or process and do not account for the physical goods being detached from the “tag”. The inability to verify data and that a digital representation is paired with the physical object prevents the use of digital wallets for this purpose since a digital wallet does not include such as pairing. Previous attempts to verify such transactions fail to pair a physical object with a digital representation, disadvantages that can be seen in United States Patent Application Publication 20190303919.

It would be an advantage to have a system that can verify the paring of physical objects such a vehicles and parking spots with virtual representations so that information systems can be used to track physical objects with reduced or eliminated risks that the digital representation no longer represents the original physical object.

It would be advantageous to have a system that can provide for multi-party verification of the pairing of a physical asset with a virtual representation for tracking of the physical asset and the associated project.

### SUMMARY OF THE SYSTEM

The computerized system can include a computer system in communication with an immutable storage; a first data capture device in communications with the computer system; a second data capture device in communications with the computer system; a set of computer readable instructions included in the computer system configured for: receiving an event record (E₁) from the first data capture device including a first location (L₁), a first time (T₁) and a first set of metadata (M₁) wherein the first set of metadata includes an original digital representation captured by the first data capture device of the physical object, receiving a subsequent event record (E₂) from the second data capture device including a second location (L₂), a second time (T₂) temporally subsequent to the first time and a second set of metadata (M₂) wherein the second set of metadata includes a subsequent digital representation captured by the second data capture device of the physical object, and, determining if the original digital representation is equivalent to the subsequent digital representation thereby providing for verification that the same physical object transitioned from an originating event to a subsequent event. The event record can represent an event that can include determining a vacant parking spot, determining an occupied parking spot, vehicle information, vehicle location, user information, account information and any combination or change in status or state of any combination.

The geofence area record, user record, and other information can include a verification code that can be used to verify that the data in the record remains accurate from its creation of from another time. The verification code can have several embodiments including checksum. A checksum can be small block of data, usually digital, derived from another block of digital data configured for use for detecting errors that can occur transmission, storage or unintentional or intentional tampering with the data. A first record can have a first checksum. A second record can have a second checksum. The second checksum can be derived from the first and the second record so that alteration of the first or second record can be detected with the second checksum.

The verification can be a hash. A hash can be a mathematical function that is configured to converts an input, such as a data record, into an encrypted output, typically having a fixed length. Therefore, a unique hash can be the same size regardless of the size of amount of the input (e.g., data). Further, the hash can be configured to prevent reverse-engineering of the input because the hash functions is a one-way function. When analyzing a record, such as an event record, comparing a first hash that can be created and stored with the event record and a second hash calculated when the event record is retrieved can provide validation that the data is unaltered from storage to retrieval. The verification code can be the hash.

The records can also include the validation code that is created according to a set of validation rules. These rules can control what information can be included in a record and verification that the record includes data or at least the type of data that is contained in the record. Validation rules can include data type, code type, range check, format check, consistency check and uniqueness check. These rules can be used to both assist with the type of data inputted and whether the data has been altered from storage to retrieval. Validation can also be performed with sampling a subset of data or records from a database and extrapolating accuracy of the data from origin creation to storage through retrieval.

In one example, a record is an input that is processed with computer readable instructions configured with a hashing algorithm that can include a secure hashing algorithm, message digest algorithm, Keccak, RACE integrity primitives evaluation message digest, Whirlpool, BLAKE, and the like and any combination. The output can be a first verification code and that first verification code is stored on an immutable ledger or other secure location. The hashing algorithm can be deterministic so that the input will results in the same output. The hashing algorithm can be configured to prevent the ability to see or read the data that is the original input. The hashing algorithm can be configured so that a small change, even one byte, will change the output. Therefore, the first output of the data will not match the second output if the data is changed between when the first data and the second data is determined.

The set of computer readable instructions can include instructions for determining if a similarity between the original digital representation and the subsequent digital representation is within a predetermine range. The first data capture device can be remote from the computer system. The subsequent event record can include a verification data representing that verification of the physical object subject to the subsequent event is the same physical object associated with the originating event according to the first event record. The set of computer readable instructions can include storing the first event record on the immutable storage and the set of computer readable instructions for determining if the first digital representation is equivalent to the subsequent digital representation includes retrieving the first event record from the immutable storage. The subsequent event record can include a verification data representing that an individual viewed the metadata of the first event record and compared it with the physical object. The second set of metadata is taken from sources from the group consisting of public records, enterprise software, computer device or any combination thereof.

The computerized system can include a computer system in communication with an immutable storage; a set of computer readable instructions included in the computer system configured for: retrieving a first event record (E₁) from the immutable storage wherein the first event record includes first location (L₁), a first time (T₁) and a first set of metadata (M₁) wherein the first set of metadata includes a first digital representation captured by a first data capture device of the physical object, retrieving a subsequent event record (E₂) from the immutable storage including a second location (L₂), a second time (T₂) temporally subsequent to the first time and a second set of metadata (M₂) wherein the second set of metadata includes a subsequent digital representation captured by a second data capture device of the physical object, and, determining if a similarity exists between the original digital representation and the subsequent digital representation is within a predetermine range.

The set of computer readable instructions can include instructions for determining if the physical object is the same physical object represented by the first digital representation during an occurrence of a second event. The subsequent event record can include a verification data representing that verification of the physical object subject to the subsequent event is the same physical object associated with the first event. The subsequent event record can include a verification data representing that an individual viewed the metadata of the first event record and compared it with the physical object. The first data capture device can be a remote from the computer system and the second data capture device.

The system can include for verifiably pairing a physical object with a digital representation comprising: a computer system in communication with an immutable storage; a data capture device in communications with the computer system; a set of computer readable instructions included in the computer system configured for: retrieving a first event record (E₁) from the immutable storage wherein the first event record includes a first location (L₁), a first time (T₁) and a first set of metadata (M₁) wherein the first set of metadata includes a first digital representation captured by a first data capture device of the physical object, creating a subsequent event record (E₂) from the data capture device including a second location (L₂), a second time (T₂) temporally subsequent to the first time and a second set of metadata (M₂) wherein the second set of metadata includes a second digital representation captured by the data capture device of the physical object, and, determining if a similarity between the first digital representation and the second digital representation exists.

The computer readable instructions can include instruction for determining if the similarity is within a predetermine range. The computer readable instruction can include instructions for determining if a similarity between the first digital representation and the second digital representation exists includes retrieving the first event record from the immutable storage. The subsequent event record includes a verification data representing that verification of the physical object subject to the subsequent event is the same physical object associated with the first event according to the first event record. The data capture device can be a first data capture device; and the computer readable instruction can include instructions for determining if a similarity between the first digital representation and the second digital representation exists includes retrieving a first image of the physical object, comparing the image to a second image captured by a second data capture device and determining if the images represent the same physical object. The instructions can determine if a similarity between the first digital representation and the second digital representation exists includes capturing an object indicium affixed to the physical object, comparing the indicium on the object at the subsequent event to a digital indicium included in the first event record. The subsequent event record can include a verification data representing that an individual viewed the object indicium and compared it with the digital indicium retrieved from the immutable storage and included in the first event record.

In one embodiment, the system can provide a hashed event record where the event record can include metadata associated with a capture device as well as indicium associated with the physical object and store the record on a blockchain platform including the platforms associated with Bitcoin, Ethereum and the like.

The computerized system can be directed to a dynamic allocation of a spatial area for vehicle parking comprising: a server having a computer readable medium; a geofence area record stored on the computer readable medium representing a physical parking spot disposed in a physical parking area wherein the geofence area record is verifiably paired with the physical parking area; a user database having a user record digitally representing a user wherein the user record includes an association with a financial account; a remote computer device in communications with the server and configured to capture location information and visual information; a set of computer readable instructions stored on the computer readable medium configured for: receiving a location information captured by the remote computer device, receiving a visual information captured by the remote computer device, associating the location information with the physical parking spot according to a comparison of the location information with the geofence area record, determining the vehicle identification according to the visual information, associating the vehicle identification with the user record, and, actuating a debit of the financial account associated with the user.

The location information can include location metadata and the set of computer readable instructions are configured for verifying a location of the vehicle according to a comparison of the location metadata with a geofence area metadata. The visual information can include visual information metadata and the set of computer readable instructions are configured for verifying a location of the vehicle according to a comparison of the visual information metadata with a geofence area metadata. The geofence area record can include an availability data and the set of computer readable instructions are configured for determining a time that the location information is captured and transmitting a vacancy information to the remote computer device.

The set of computer readable instructions can be configured for transmitting vacancy information to the remote computer device. The geofence area record can include an availability data and the set of computer readable instructions are configured to transmit an expiration notification to the remote computer device representing that a vehicle authorization to occupying the physical parking spot has expired. The set of computer readable instructions can be configured for transmitting the expiration notification a predetermined period of time prior to an expiration of an allotted time. The actuating of the debit of the financial account can be an actuation of a first debit of the financial account and the set of computer readable instructions are configured for actuating a second debit of the financial account representing that a vehicle has occupied the physical parking spot past allotted time. The set of computer readable instructions can be configured for transmitting an expiration information to the remote computer device. The set of computer readable instructions can be are configured for transmitting a first amount of the debit to a first entity and transmitting a second amount of the debit to a second entity. The first entity can be a management company, and the second entity can be a parking lot owner.

The set of computer readable instructions can be configured for receiving a vehicle location information, transitioning a status included in the geofence area record from occupied to available and actuating the debit of the financial account according to detecting a vehicle leaving the physical parking spot. The set of computer readable instructions can be configured for receiving a parking spot reservation and transitioning a status included in the geofence area record from available to reserved. The set of computer readable instructions can be configured for receiving a parking spot reservation and transitioning a status included in the geofence area record from available to reserved.

The system can include a geofence area record stored on the computer readable medium representing a physical parking spot disposed in a physical parking area; a user database having a user record digitally representing a user wherein the user record includes an association with a financial account; a remote computer device in communications with the server and configured to capture location information and visual information; a set of computer readable instructions stored on the computer readable medium configured for: actuating a debit of the financial account associated with the user upon receiving a reservation request, transitioning a status included in the geofence area record from available to reserved, receiving a location information captured by the remote computer device, receiving a visual information captured by the remote computer device, associating the location information with the physical parking spot according to a comparison of the location information with the geofence area record and the reservation request, and, transitioning the status included in the geofence area record from reserved to occupied according to the comparison of the location information with the geofence area record.

The set of computer readable instructions can be configured for crediting the financial account according to a violation information received by the remote computer device. The system can include a violation system wherein the violation system can be configured for debiting the financial account of the user according to a determination that the physical parking spot is occupied by a violating object. The remote computing device can be taken from the group consisting of a vehicle tracking systems, an entertainment system, a smart phone, a telematics device, an event data recorder, and any combination.

The set of computer readable instructions can be configured for: transmitting a status of the physical parking spot to the remote computer device, receiving a location information captured by the remote computer device, receiving a visual information captured by the remote computer device, associating the location information with the physical parking spot according to a comparison of the location information with the geofence area record, associating a vehicle with a user account according to the visual information, and, debiting a financial account associated with the vehicle.

The set of computer readable instructions can be configured for receiving a reservation information and debiting a financial account associated with the vehicle according to a determination that the vehicle disposed in the physical parking spot is not associated with the reservation information. The set of computer readable instructions can be configured to transmit a violation information to a enforcement computer system according to a determination that the vehicle is disposed in the physical parking spot past an authorized period of time. The set of computer readable instructions can be configured for aggregating a plurality of geofence area records and transmitting a full lot information to the remote computer device according to a determination that each physical parking lot is occupied or reserved.

### BRIEF DESCRIPTION OF THE DRAWINGS

FIG. 1A is a diagram of aspects of the invention;

FIG. 1B is a diagram of aspects of the invention;

FIG. 1C is a diagram of aspects of the invention;

FIG. 2A is a schematic of aspects of the invention;

FIG. 2B is a schematic of aspects of the invention;

FIG. 3 is a diagram of aspects of the invention;

FIG. 4 is a diagram of aspects of the invention;

FIG. 5 is a diagram of aspects of the invention;

FIG. 6A is a schematic of aspects of the invention;

FIG. 6B is a schematic of aspects of the invention;

FIG. 7 is a diagram of aspects of the invention;

FIG. 8 is a diagram of aspects of the invention;

FIG. 9 is a diagram of aspects of the invention;

FIG. 10 is a schematic of aspects of the invention;

FIG. 11 is a schematic of aspects of the invention; and,

FIG. 12 is a diagram of aspects of the invention;

### DETAILED DESCRIPTION

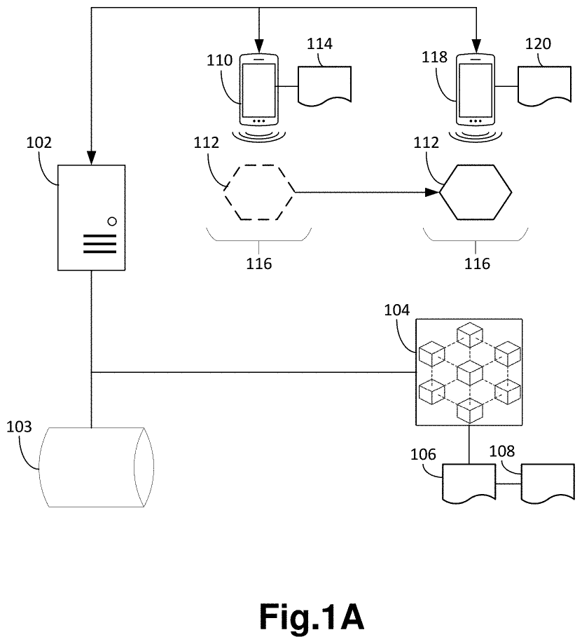

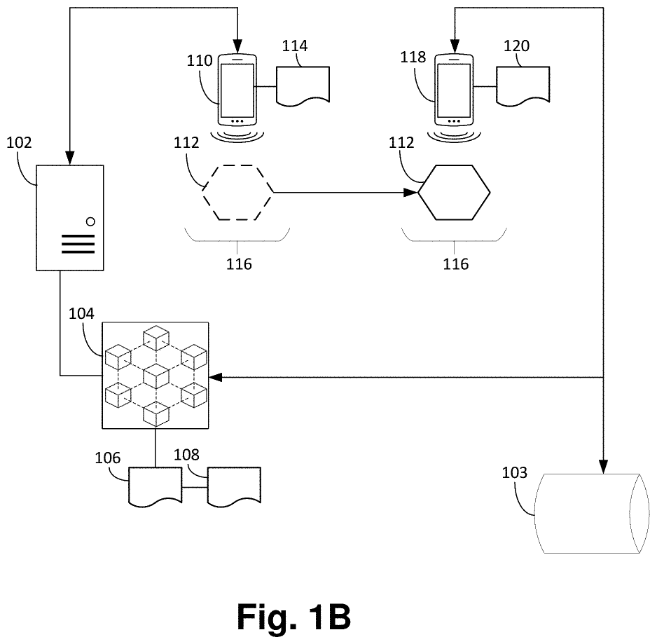

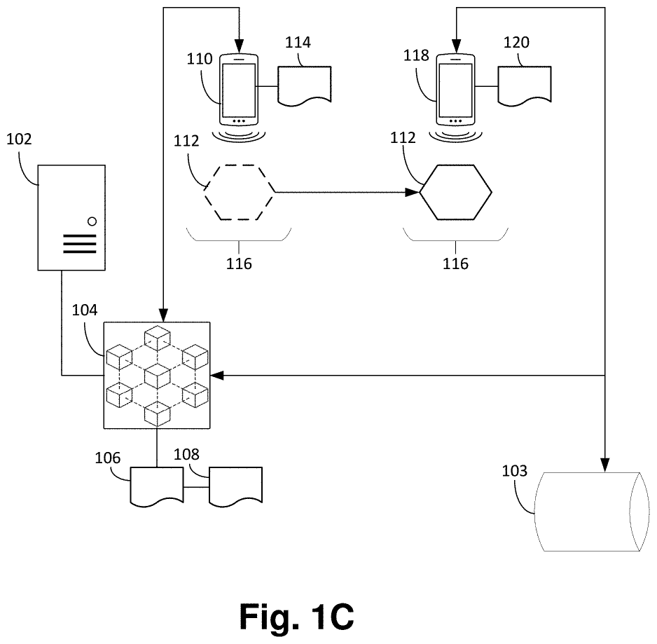

The present system provides for verified pairing of a physical object with a virtual representation. Referring to FIG. 1A illustrates a computer system 102 can be in communications with a database 103 and a second data storage system 104. Each of the data storage systems can be centralized, decentralized, immutable, distributed, local, remote, shared, private, virtual and any combination. The first data system can differ from the second data system. The first and second data storage systems can be immutable and persistent so that the information stored on the data system, once storage, cannot be changed. The data systems can include a plurality of computer systems where data can be copies onto each computer system. Examples of data storage platforms include hard drives, solid state drives, tapes, and cloud storage systems. The immutable data storage system can use blockchain, crypto-shredding, WORM, append only, distributed ledger technology, immutable cloud storage, immutable record retention (e.g., Oracle Cloud Infrastructure Object Storage, Quantum Ledger Database, and any combination thereof). In one embodiment the immutability is accomplished by the data storage system only allowing records to be appended to the storage media without the ability to modify the record once written. One such system includes blockchain. When a first record 106 is written to the data storage system, the record cannot be changed. When a second record 108 is written to the data storage system, it is stored later in time to the first record thereby effectively providing a chronologically trail of events associated with the physical object and digital representation. Attempts to improperly tamper with the immutable storage can be discovered when the metadata of the first record and the second record are inconsistent with the first record and the second record being stored chronologically.

In operation, a first data capture device 110 can be in communications with the computer system 102 so that data captured by the first data capture device can be transmitted to the computer system. The first data capture device can have a first capture device metadata 114 originating from the data device that can be included in the first record 106. The first data capture device can also capture object data associated with the physical object. Object data can include an image of the physical object, tag, label, RFID, weight, dimensions, and other indicia and any combination thereof. The object data can be captured at a first event 116 that can include a change in state of the physical object, change in location change in time or any combination thereof. When an event occurs, which can be a second event, a second data capture device 118 can have a second capture device metadata 120 originating from the data device that can be included in the second record 108. The second data capture device can also capture object data associated with the physical object 112 at the second event.

The first capture device metadata and object data can be used to create the first record which can be a first event record. The first event record can be stored on the immutable storage. The second capture device metadata and object data captured by the second data capture device can be used to create the second record which can be a second event record. The second event record can be stored on the immutable storage. Immutable storage can be a storage medium or system where the data or object being stored cannot be changed or modified after its storage.

During data capture by the first data capture device, object indicia can be capture where the object indicia is associated with the object. The object indicia can include a still image of the object, a label affixed to the object, a radio frequency identification (RFID) tag, an ultra-high frequency (UHF) tag, a bar code, a QR code, a Bluetooth beacons, alpha-numeric characters, and any combination thereof. The object indicia can be included in the first event record and stored on the immutable storage. When a change in time, location or other event occurs the second data capture device can capture the object indicia. Once captured, the object indicia can be compared to the object indicia in the first event record and if the two matches, then verification exists that the physical object associated with the second event is the same physical object that was present at the first event. In one embodiment, the second capture device can capture data, transmit the data to the computer system 102 and computer readable instructions on the computer system can perform the comparison of the object indicia capture as the second event with the object indicia included in the first event record.

Referring to FIG. 1B, the second data capture device can be in communications with the immutable storage and database 103. Computer readable instructions on the second data capture device can capture the object data at the second event, retrieve the first event record, compare the object indicia from the second capture device with the object indicia of the first event record and determine if the physical at the second event is the same physical object at the first event. In one embodiment, the second data capture device can store a second event record that can include object indicia capture at the second event on the immutable storage. The computer system can be notified that a second event record has been stored. The computer system can retrieve the first event record and the second event record and compare the respective object indica to determine of the physical object is the same physical object at the first event and the second event. If the object indicium is not the same, a notification can be provided indicating that the physical object has been changed, modified or otherwise different between the first event and the second event.

Referring to FIG. 1C, the first data capture device can be in communication with the immutable storage and database 103. In one embodiment, the first data capture device can capture data at a first event that can include object indicia, create a first event record, and store the first event record on the immutable storage. The second data capture device can retrieve the first record having the object indicia from the immutable storage and compare the object indicia captured by the second data capture device with the object indicia of the retrieved first event record.

The first data capture device and the second data capture device can be the same device.

The system can therefore pair the physical object with a digital representation, such as an object indicium, and verify among events that physical object has not been improperly changed. This system can provide for verifications at each event that the physical object has not been replaced, modified, or otherwise changes. An event record created with this process can have a verification code associated with is so that validity of the event record can be determined.

The geofence record can be associated with a parking first event and the second event record can be associated with a second event. The data associated with these events can be retrieved from the capture device and used in creating and writing the associated event record. If the date and time setting of the data capture device are incorrect, this discrepancy can be identified by comparison with the event record created and compared to related records in the immutable storage. In one embodiment, metadata integrity used by the system can be designed to identify inconsistencies with date and time. For example, a drone can be used to capture one or more images from a project, such as construction roof project, and the drone may experience date and time inaccuracies so that the date and time in its metadata is in error. The data can include the recorded data and the metadata. The error or inconsistency can be identified by comparing the irregular time of the drone and the hash/block time of the metadata that was committed to the persistent storage layer. The difference can be with a range that results in an alert being sent to a user. This alert allows the users to remedy the error, repair the device (e.g., drone) and mitigate risk of date and time, and other inconsistencies, in the future.

The first event can differ from the second event by time, activity, process, location, or any combination. In one embodiment, metadata associated with the event and event record and a ledger hash time, representing when the event record is stored (e.g., committed) to the immutable storage can be used to validate the metadata provided from the data capture device. If the data capture device has an incorrect time, a comparison of the ledger hash time with the metadata from the data capture device can identify an error. Identifying an error can be used to alert users to data capture device issues and can indicate that the data capture device needs to be serviced or replaced prior to its next use.

The metadata that can be associated with the capture device can include weather conditions, which can include a sun angle, which can be compared with environmental weather conditions to approximate the data capture time. Metadata associated with an image of video can be used to verify weather conditions in the image or video. Time and location metadata can be retrieved from publicly sources or remote sources and captured with the device metadata to determine of the captured weather in the image or video is the same as being reported locally on that day and at that time.

In one example, a drone can be the capture device and images, or video captured from the drone of a physical object such as a roof can show repairs that occur over time. In the event that the drone footage was disputed, metadata that can include location, date and time and comparing weather visible in drone footage to reported weather conditions to add verification to the drone metadata. In one example, data associated with a worker, such as a vehicle, license plate, of other indicia can be captured by the drone. For example, if a license plate can be captured, the license plate information can be compared with public data and the attendance of the worker at a location or physical object can be verified.

The metadata that is captured can be dependent upon the device and can include metadata associated with a worker, equipment, weather, enterprise software, security hardware and software, material, indicia, smart contracts, public records, authentication information, date, time, location, entity and any combination of these examples. The biometric data may include facial recognition, an iris/retinal scan, a fingerprint scan, a hand scan, a voice print, or heart rate signature and any combination.

In one embodiment, an image or video captured can be used to identify an approximate time where data was captured by the data capture device. The metadata associated with the data capture can include weather conditions, sun angle, which can be compared with environmental weather conditions to approximate the data capture time. In one embodiment, the data capture can include the location so that the location of the data capture device can be used to retrieve environmental weather conditions when the data capture occurs.

The data capture device can capture data in response to an event associated with the physical object. For example, if the physical object changes location, is modified, transferred, integrated, or other action, process or procedure associated with the physical object can signify an event.

A location can include a manufacturing place, construction site, business providing services, origination site, delivery site, event site, or other location where an object or materials will be used including the creation, collection, maintenance, repair, use, or integration of the object or material.

Verification, including verification of an event, can include verifying that the physical object and the virtual representation match and can be accomplished in a variation of methods including interaction with identification elements such as a tag, label, and the like, capturing an image of the material, capturing a video of the material, capturing indicia such as a tag physically affixed or otherwise associated with the material, human visual inspection, and any combination. Identification of an individual performing or otherwise associated with an event can be captured by identification devices (e.g., cards, tags, RF ID) and biometrics including visual capture (e.g., facial recognition), voice recognition, iris scan, fingerprint, palm print, weight, dimensions, change in weight, dimensions or other attributes, and any combination. Examples of verification processes can include having stored data about the physical object and comparing the physical object with the date, using machine learning process video, using imagery, audio clips and other media to and any combination. Individual human inspectors can be used to verify physical objects and events onsite and offsite. Individuals can process video, imagery, audio clips and other media to verify assets and events and provide the verification to the system at one or more events. Upon verification of an event, smart contracts can be executed according to verification of the physical object and event.

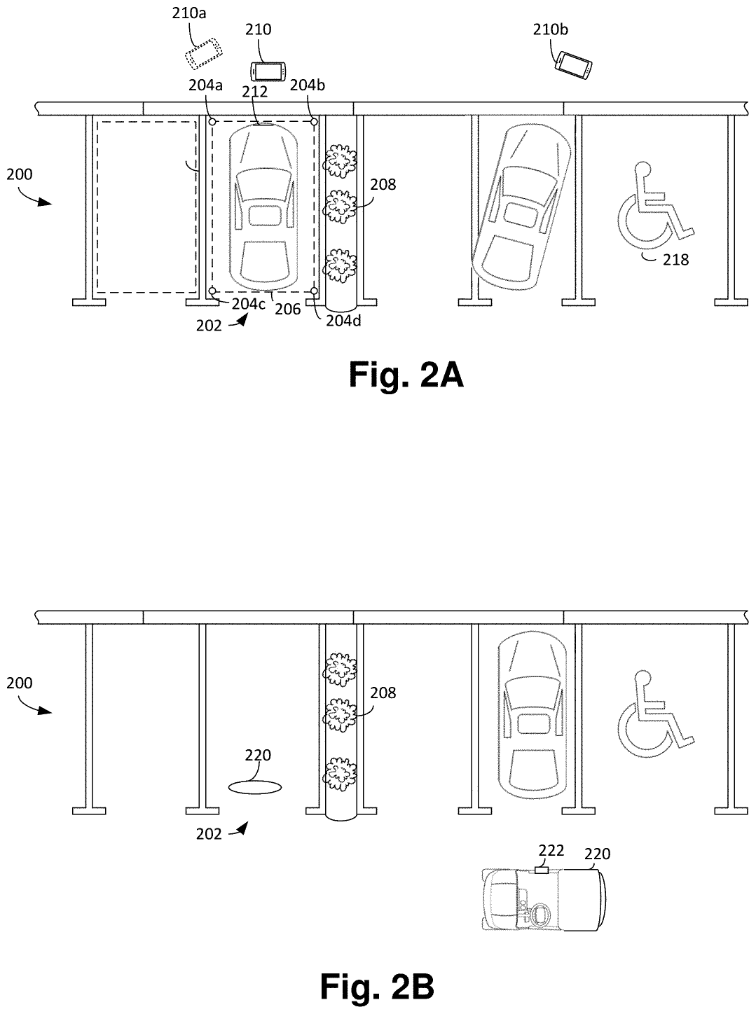

Referring to FIG. 2, a parking area 200 is shown having a physical parking spot 202. The physical parking spot can be associated with a digital representation that can include location coordinates such as four coordinates that correspond to the corners of the physical parking spot 204a through 204d. The location coordinates can be used to define a geofence 206 associated with the physical parking space. A server can have a geofence record that include the geofence associated with the physical parking spot. The geofence can be defined in any number of ways including a single location point and a distance from the point. The point can represent a portion of the physical parking spot and the geofence defined by a certain distance in one or more directions from the point. For example, the point can represent a corner 204a of the parking spot and the geofence defined a first distance toward 204b and a second distance toward 204c and the area defined by a rectangle intersection these three points. A parking area can have multiple parking spots defined within the parking area.

When defining the geofence for the parking spot, the geofence, or digital representation, can be verified to be properly paired with the physical parking spot using any method described herein. One method is to define the geofence with GPS information, capture an image of the physical parking spot with the GPS information, overlap the geofence with the physical parking spot on a computer device, display the geofence with the physical parking sport by augmented reality on the computer device and receive verification that the geofence properly overlays with the physical parking spot. For example, if the geofence overlay intersects the landscaping 208, the geofence should be redefined as the geofence is outside the parking spot.

The system can include a user database that includes user records. The user record can include user account information, financial information, vehicle information and the like. A user can access the system and be associated with a user account on computer readable instructions stored on a remote computer device 210 such as a smart phone either through an app or browser. Therefore, the user interface can be local or remote to the user's remote computer device. In operation, the user can place a vehicle in a parking spot and exit the vehicle. The user can be positioned so that an image of a vehicle identification, such as a license plate 212, can be captured by the remote computer device. The computer readable instructions can determine the position of the remote computer device by the image of the vehicle identification. For example, if the user positions the remote computer device at 210a, the image of the vehicle identification can appear as having a larger proximal side than the distal side and the angle 214 where the remote computer device is positioned can be calculated. The computer readable instructions can inform the user to position the remote computer device in front of and parallel to a long axis of the vehicle. An image of the vehicle identification can be retaken and verified to be properly positioned by the angles calculated from the image.

The image taken can also use line marking 216 to determine the angle of the remote computer device relative to the long axis of the vehicle and direct the user to properly position the remote computer device. In one embodiment, the image can detect that while the angle of the remote computer device is generally parallel to the long axis of the vehicle, the vehicle is not in a proper position. Remote computer device 210b can capture an image of the vehicle as from the parking spot lines, determine that the vehicle is positioned incorrectly and request that the user reposition the vehicle into the proper parking spot. In this manner, verification that the vehicle is properly parked can be determined. In one embodiment, the remote computer device can capture use indication images such as signage 218 that is associated with a parking spot indicating that the parking spot is limited to certain vehicles or other authorization. The use indication images can be on the ground, sign poles, colored curbs, colored marking lines and the like and in any combination. The remote computer device can capture proper vehicle authorization information such as hang tags, license plate indicia, stockers, and the like so that a comparison can be made to determine if the vehicle is authorized to be in that indicated parking spot. If not, the system can provide a warning, issues a fine, transmit a violation to an enforcement entity, indicate violations in the user account, associate a violation with the vehicle, associate the violation with the remote device and the like in any combination.

When the remote computer device captures an image, the location of the remote computer device can be determined. The location can be used to associate the vehicle, user, parking spot and any combination. The system can transition the status of the parking spot from available to occupied when the system receives an image of the vehicle or vehicle identification disposed in the parking spot and associated metadata. The associated metadata can include date, time, location, device, device information, user information, and the like. The remote computer device can capture weather, shadows, surrounding objects, and the like. The surrounding objects can be used to verify that the vehicle is associated with the proper geofence. For example, geofence 206 can be associated with landscaping 208 so that if the remote computer device captures the landscaping, a verification can be provided that the vehicle and remote computer device as disposed at the proper location. In one example, if the landscaping is changed or removed and the system detects that the image captured at or near the parking spot should have the landscaping, an indication to verify that the geofence is still valid can be transmitted to a user. The use of this and other metadata can provide verifications that the digital representations are properly paired with the physical objects and locations.

Referring to FIG. 2B, the geofence area record or parking spot record can include a status that is taken from the group consisting of occupied, available, reserved, violation, under repair, needs repair, and any combination. This status be for each parking spot 202 in a parking area 200 and can be transmitted to the remote computer device and a display associated with the system to inform users or the status of the parking spot. An indicator 220 can be a visual indicator that can include alpha numeric content, color or other indicator representing the status of the parking spot. The status can be provided to a user through a computer device, including the remote computer device, and allow the user to see multiple parking spots and their respective status. The user can select a parking spot from a remote computer device and reserve the parking spot. The system can, upon receiving the reservation, debit a financial account associated with the user or the vehicle or both.

When a vehicle occupies a parking spot, one embodiment includes a time period when the vehicle may occupy the parking spot. When the expiration of the time period occurs, or a predetermined period of time prior to the expiration, a warning or expiration notification can be transmitted to the remote computer device. The user can determine the period of time prior to the expiration allowing sufficient time to return to the vehicle. The user may also elect to extent the time which can results in an additional debit from the financial account. In one embodiment, the remote computer device can capture the vehicle identification and transmit the image, date, time and location to the server and the server can determine if the vehicle located in the parking spot associated with the location of the remote computer device is in violation. The remote computer device does not need to be associated with the vehicle, vehicle owner, or vehicle operator or the respective accounts. In the case, the violation information can be transmitted to an enforcement entity, or a warning or other notification can be transmitted to the remote computer device associated with the vehicle. This functionality allows third parties to act as enforcement entities.

When a user is in violation, the system can automatically debit the financial account according to the violation, notify an enforcement company such as a towing company, notify a regulatory entity such as law enforcement, and any combination. With vehicles with ignition locks, safety locks, electronic locks and the like, the system can transmit to signal to the vehicle to prevent the vehicles operation until the violation is satisfied such as a paid fine, which can be paid through the computer readable instructions.

When reserving or using a parking spot, the system can debit an account associated with the user and automatically transmit funds to another entity including a management entity or parking lot owner. In one embodiment, the remote computer device can transmit location information to the service representing that the vehicle has left the parking spot and the user account can be debiting according to the time or other use information of the parking sport. The system can then transition the status of the parking spot from occupied to available. The system can also inform users that the parking spot is open in the event that a user device to enable push notifications concerning parking spot status. The system can receive location of the remote computer device and push parking spot status to the remote computer device according to the location of the remote computer device.

In the event that a user reserves a parking spot and upon arrival, another vehicle is occupying the spot, the user can capture the vehicle identification and location of the vehicle in violation and send the information to the server. The server can credit the user reserving the parking spot, provide information about the status of other parking spots, send a warning or violation message to the user in violation, debit the violators financial account, contact an enforcement entity and any combination. The violators user account can be updated with information concerning the number of violations and a ranking of compliance associated with that user. Information can be capture by the remote computer device and can include information from a vehicle tracking system, an entertainment system, a smart phone, a telematics device, an event data recorder and any combination.

In one embodiment, a mobile unit 220 having an image capture device 222 and location information that can be transmitted to the server as the mobile unit travels through a parking area. The images captured can include open parking spots and occupied parking spots and can be transmitted to the server. The server can receive the information an verify occupancy, vehicles and other information previously received from a remote computer device.

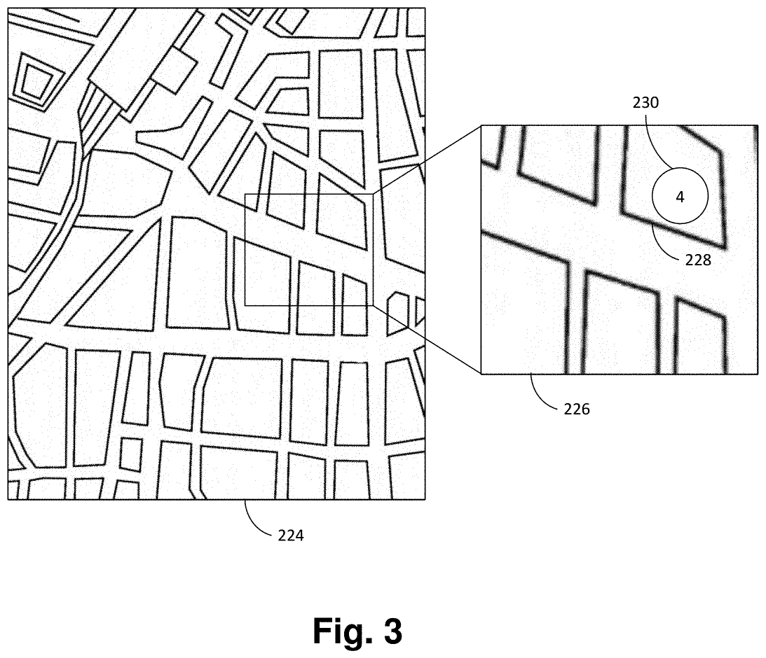

Referring to FIG. 3, the computer readable instructions can display a map 224 of a specific area that is selected by a user. The user can select to view a portion 226 of the map. The computer readable instructions can indicate a parking location 228 and with indicator 230 inform the user that there are a certain number of parking spots open, no parking sport open, parking spots reserved, parking spots that have allotted time expiring in a range prior to the expiration or other status information. The indicator can be alphanumeric, colored or provide another indication. The user can select a parking area or parking spot for status information reservations and the like.

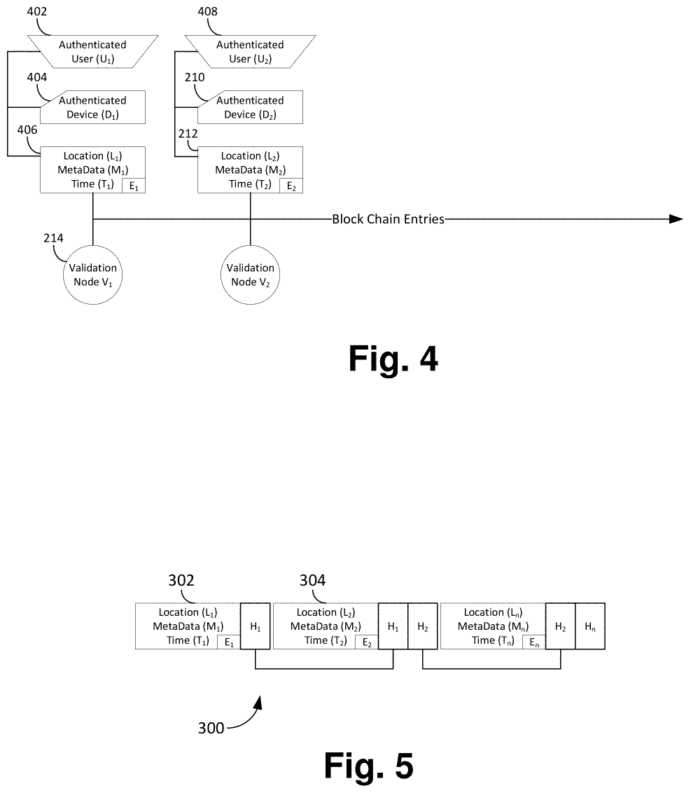

Referring to FIG. 4, one embodiment the user of a remote computer device can be verified at 402 so that the user can be authorized to use the remote computer device or to perform data capture at the first event. The remote computer device can be authenticated at 404 representing the remote computer device is the correct remote computer device and is in working order. The metadata that can be captured by the remote computer device can include a location, a time and additional metadata shown as 406. The user can be a first user and in one embodiment a second user of a remote computer device can be verified at 408 so that the user can be authorized to use the remote computer device or to perform data capture at the first event. A second remote computer device can be authenticated at 210 representing the remote computer device is the correct remote computer device and is in working order. The metadata that can be captured by the remote computer device can include a location, a time and additional metadata shown as 212. In one embodiment, the first event record and the second event record can be committed to immutable storage such as blockchain using validation nodes included in the immutable storage structure. A validation 214 can be created and stored. The event record E₁, which can be represented by data taken from U₁, D₁, L₁, M₁, T₁, or other data, can have a validation code V₁. When the even record is retrieved, a second validation code V₁ₐ can be determined and compared with V₁. If these validation codes match or are within an acceptable range, validity of the data from storage to retrieval can be determined.

Referring to FIG. 5, in one embodiment the second event record 504 can be linked to the first event record 502 to create a digital audit trail 500 that includes object indicia verifying that the physical object remains the same physical object throughout a process or where the physical object was modified, changed or otherwise different during the process. A validation record can be created for the first event, the second event, the first plus second event and any combination including the inclusion of n additional records. The system can also record changes in the event or object including changes in the locations, time biometrics of an associated individual, thereby providing an audit trail of the changes.

The computer system can be contained in a housing such as a kiosk and can be physically associated with one or more parking areas. In one embodiment, the server, kiosk or remote computer device can include a sensor and reader which can be selected from the group consisting of radio frequency identification (RFID) detector, ultra-high frequency (UHF) detector, a bar code scanner, a QR code scanner, near frequency communication (NFC) device; Bluetooth beacons, an optical character recognition (OCR) device and any combination thereof. An environmental sensor, such as a weather sensor or weather station, can be in communications with the or included in the housing and configured to record the weather and other environmental conditions at the location and at different times during the project. If the environmental sensor detects a change in the environmental condition, it can represent an event.

The system may record the date and time of events such as the arrival and departure of materials, individuals, workers, supplies, third parties, inspections, and the like to and from the project location, the date and time associated with environmental conditions including weather. The environmental conditions can be used to modify the schedule for workers so that workers are not working during inclement weather, tasks are not preformed outside specified environmental conditions, and materials are delivered and installed during specified environmental conditions.

The system may track the movement of material at a project location or during a process or to and from the project location thereby creating an audit trail associated with the material. Scanning technology such as RFID readers, UHF readers and/or the like may be utilized to assist the location tracking for tools, equipment, materials and even workers. The tracking the material assists with reducing the risk of loss, theft, mis-delivery, and the like. For example, the tracking solution may indicate instances of possible theft, such as when the materials are leaving the project location when the removal of the materials is not proper.

The system may allow for the establishment of one or more geofenced zone that can be associated with delivery areas, worker entrance exit areas, task areas, storage areas, assembly areas, distribution areas and any combination thereof. These areas could be monitored and established with access allowances or restrictions to control movement of material, individuals and equipment to assist with the prevention of loss, mistakes, inefficiencies, and damage. The system can assist with verification that materials stored-on locations are consistent with specifications associated with the materials. A first event can be the material being deposited at a location in a first zone and a second event can be the material being deposited at a second zone. The first event can be associated with the object at a first zone and a second event can be associated with the object in the same zone, at a later time.

The system can also use smart contracts associated with events and stored on the immutable storage that can be self-executing upon satisfaction and verification of contractual terms and objects associated with an event. For example, when an object is delivered from a shipper to the receiving entity and the receiving entity verifies that the object was properly delivered, a smart contact that instigates payment to the shipper can be performed.

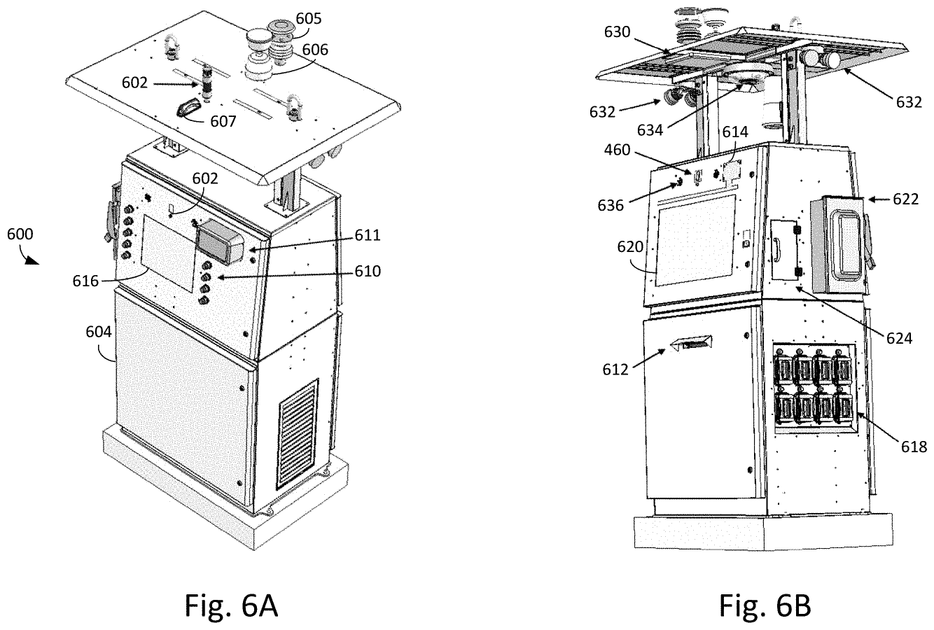

Referring to FIGS. 6A and 6B, in one embodiment the computer system can be contained in a housing 604 can be physically associated with the project location, virtually associated with the project location or both. The housing can be a kiosk in one embodiment. A unique location marker can be disposed at the project location to uniquely identify the project location. For examples, a transmitter such as a RFID can be associated with the project location by embedding it is a permanent fixture such as a concrete slab, foundation, structure, and the like. The system can read the information from the location marker and associate its actual location with the project location. The location marker can include an alpha, numeric, or graphical information such as a number, letters, barcodes, QR code, physical or geographic coordinates (e.g., GPS coordinates), passive transmitter, active transmitter and the like. Each system can have a unique identifier and each project location can have a unique identifier.

A first side of the system can include a camera 602 for obtaining images of materials, equipment, individuals, or other items entering or leaving the project location as well as images of individuals along a perimeter. The camera 602 may capture biometric images upon which biometric recognition may be performed. Multiple cameras may be placed on or around the housing. The cameras may have biometric recognition and motion detection capabilities. System 600 may include one or more cameras 602 that can be used as biometric-based identification devices to confirm the identity of individuals entering, leaving or on the perimeter of the project location. The system 600 may include an antenna 606 for communicating with a network including a wireless network, Wi-Fi network, Bluetooth, quantum networks, cellular network (e.g., 4G or 5G network) and any combination. The system 600 may include a housing 604 made of suitable weather resistant material, appropriately sealed to protect the internal hardware. The system 600 may include a display 616, such as a touchscreen display, upon which information may be displayed and entered. The display 616 may include an integrated camera that may be used to capture images and that may be used in performing facial recognition of individuals. The display may also include or operatively associate with one or more integrated speakers for providing audio output, a microphone for receiving audio information to facilitate two-way communications to a remote location. The system 600 may include a scanner 612 for scanning items, such as deliveries, as will be explained in more detail below. The scanner 612 may be, for example, a QR scanner, barcode scanner, an Optical Character Recognition (OCR) or another scanner 611 in some instances. Actuators such as button 610 can be carried by the housing and connected to a controller, computer medium, computer of other information processing device. One side of the system 600 can be used for deliveries and inspections. A delivery person may scan delivered materials, equipment, or other items via the scanner 611 or 612 and may interface with the system using the touch screen display 616. An inspector may scan or take images of inspection documents via the scanner 611 or 612 or camera and may interface with the system using the touch screen display 616. In some embodiments, there may be fewer sides in which to interact with the system for all authorized personnel. An overhang may be provided to assist in decreasing glare and protecting some of the items on the housing from the weather.

Another side can include a touch screen display as well as a scanner 612. Display 616 may include or be operatively associated with an integrated camera for capturing images, speakers for providing audio output and a microphone to facilitate two-way communications with a remote location. Still further, this side of the system may include data ports. The system may be accessed to gain access to equipment, tools and to sign in or sign out when leaving or entering the project location, as will be described below.

Another side of the system can include a location 620 where information such as permits, specifications, instructions, tax information, plans, and the like and may be displayed. In some embodiments, the information displayed may assume electronic form so that a video display is provided in the housing. A tax map submap (TMS) number for the project location may be displayed on the housing. Other location identifying information can be displayed such as location number, store number, assembly number, area within the project location and the like. In addition, the site address may be displayed on the system. The site address may refer to both the mailing address for the project location and/or other physically identifying information associated with the location.

Another side of the system can include an access panel 622 may be provided to access a breaker box for the system. An additional access panel 624 may also be provided to access internal components of the system. Still further, access panel 624 may be provided to gain access to power source for providing power at the project location. The access panel 618 may be under programmatic control in some instances to regulate access to the power source. If access is granted, the panel is unlocked, whereas if access is denied, the access panel 618 is locked. In some embodiments, access to the power supply may be controlled by controlling the flow of power to the power source under programmatic control from the controller. These control mechanisms may be used separately or in conjunction.

Referring to FIGS. 4A and 4B, the housing 604 can include a worker side that is configured to be used by a worker at the project location. The housing can include an alarm indicator 607 that can be actuated as described herein. The housing can include a weather station 605 that can include an integrated or separate fluid (e.g., rain) collector. Biometric reader 614 can include an iris scanner, fingerprint scanner, palm print scanner, facial scanner, or some combination. Display 616 can be proximity to input assemblies such as buttons 610. The housing can include a field receiver 430, lights 432 and camera 434. One or more cameras can provide a 360° field of view and include a wireless connection for transmitting images to a remote computer device. The images can also be used for input to the system including input allowing the system to identify delivered materials. The system can include one or more second cameras 460 such as webcams disposed at various locations around the system for capturing images. The lights can include motion activation and photoelectric activation. Speakers 436 can be included to provide audio information to a user, worker, inspector, or other party using or near the system. The audio information can include instructions, alarms, and the like. Power junction can include a shut off switch that can be used in emergency and non-emergency situations. The system can include a secondary power source, such as a battery, so that when the main power is shut off, an alarm can sound, notification send to a remote computer device of other indication that the system or power source has been powered down. The system can include a hand scanner (not shown) that can be protected by a hand scanner access door. A document scanner 612 can be included in the system for receiving physical documents, converting the physical document into a digital representation, and storing the digital representation on the computer readable medium or the immutable storage. The system or housing can include electrical outlets 618 for providing power to various tools and equipment at the project location including recharging batteries. The system can include a wired connection to remote computer devices of a transceiver to provide a wireless connection to remote computer devices.

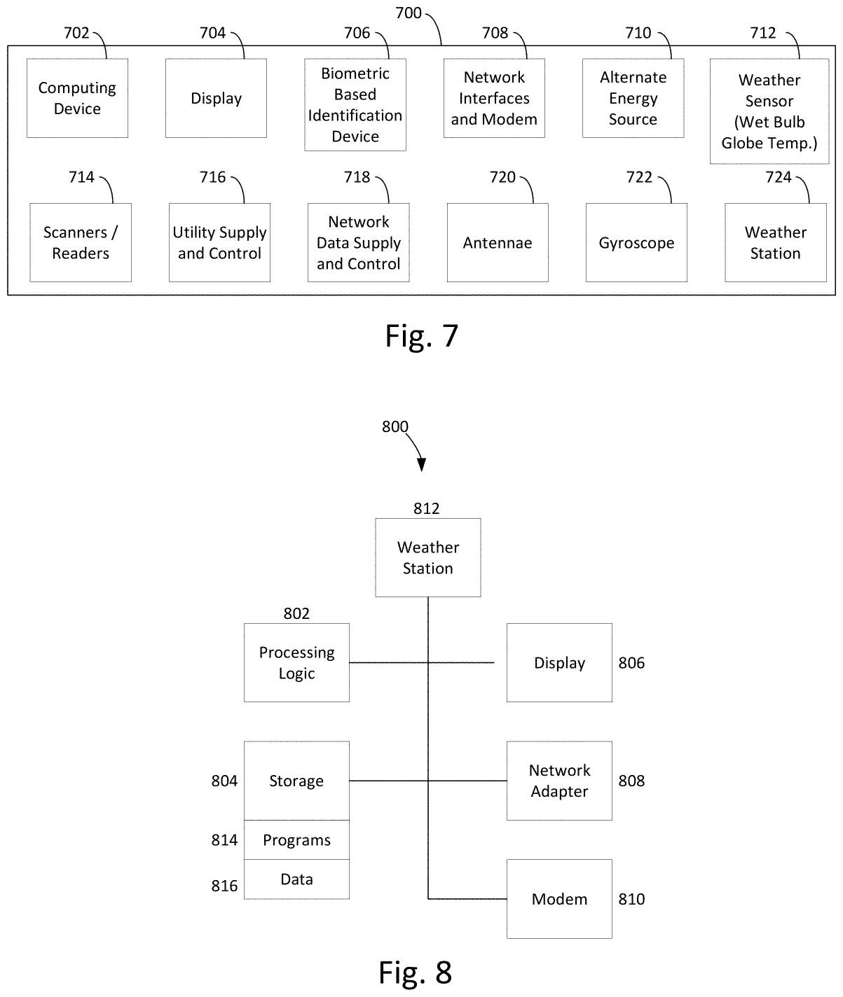

FIG. 7 depicts components that may be included in the system of exemplary embodiments even when not included in a housing. The system may include a computing device 702. The computing device 702 may take many different forms indicating a desktop computing device, a laptop computing device, a mobile computing device, an embedded system, a smartphone, special computer device, custom computer device, or the like. A display 704 may be integrated with the computing device 702 or as a separate device, such as a liquid crystal display (LCD) device, a light emitting diode (LED) display device or other types of display devices on which computer information may be displayed. One or more biometric-based identification devices 706 may be provided. As will be explained in more detail below, multiple biometric-based identification devices may be used. Network interfaces and a modem 708 may be provided. The network interfaces may interface the computing device 702 with a local area network or a wide area network wherein the networks may be wired or wireless. A modem may be provided to communicate telephonically or over cable lines with remote computing devices.

The system 700 may include various scanners and readers 714, such as those described above relative to housing. The system 700 may include a utility supply and control 716 and a mechanism for turning the utilities, such as power, gas and/or water, on and off under a programmatic control. The system 700 may include an internet data supply control 718 and a mechanism for turning the access to this service on and off under a programmatic control. Programmatic control may be provided to grant or deny access to such resources. The system 700 may include an antenna 710 for wireless communications signals to receive and transmit. The system 700 may include a gyroscope 712 to monitor any moving of the system. The gyroscope 712 may indicate motion indicative of whether someone is trying to move or tilt the housing or other component of the system. Logic may be provided to send a notification in such an event where the gyroscope indicates substantial enough movement. The system 700 may include a weather station 714 to measure current weather conditions, such as temperature, air movement, humidity, precipitation, barometric pressure, direct sunlight, and the like. Input from the weather station 714 may be used to inform decision making by the system in some instances. Alternatively, the weather may be collected via software, such as from a weather service or other weather source. Similarly, the system 700 may include a weather sensor 712. The sensor can be a wet bulb globe temperature adapted to measure, among other things, heat stress in direct sunlight, which accounts for temperature, humidity, air movement (direction and speed), sun angle and cloud cover (solar radiation).

FIG. 6 shows an example of a computing device 800 for the system. The computing system may include processing logic 802, such as microprocessors, controllers, field programmable gate arrays (FPGA), application specific integrated circuits (ASICs) electronic circuitry, and other types of logic. The processing logic performs the operations of the computing device 802. A storage device 804 may also be provided. The computer readable medium and/or data storage device 804 may take various forms, including magnetic storage, optical storage, etc. Storage capability 804 may include computer-readable media, including removable computer readable media, such as disks, thumb drives and the like, or disk drives, solid state memory, random access memory (RAM), read only memory (ROM) and other types of storage. The computing device may include a display 806, such as an LCD display, an LED display, or other types of display devices on which video information may be displayed. The computing device 800 may include a network adapter 808 for interfacing with networks and a modem 810 for communicating wirelessly, over telephone lines or cable lines with remote devices. The processing logic 802 may use information stored in the storage device 804. In particular, the processing logic 802 may execute programs 814 stored in the storage and may access and store data 816 relative to the storage device 804. The computational functionality of the system described herein may be realized by the processing logic 802 executing the programs 814.

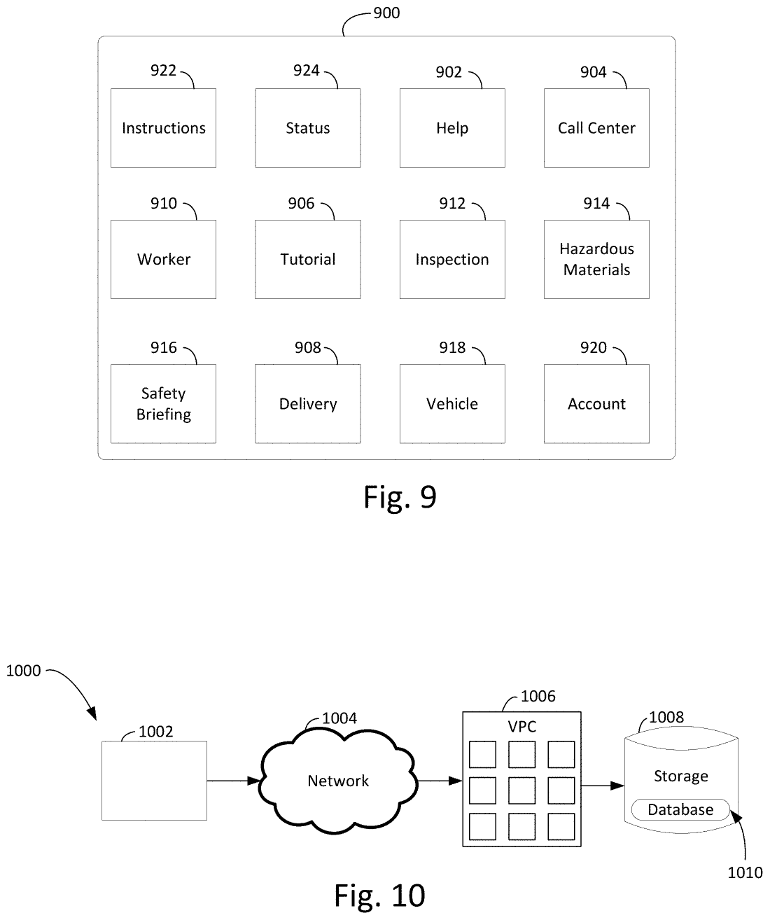

FIG. 9 shows an example of a user interface on one or more displays. The user interface may include activatable elements. A user may depress these activatable elements or select these activatable elements using an input device, such as a mouse, keyboard, touchscreen, or the like, to activate the components. The display may include a help element 902 that may be activated to obtain help information regarding use of the housing. It may also contain real time project or process plans. It may also include “how to” assistance including videos related to the various projects, stages, processes, and tasks performed at the project location. The user interface on a display may also include a call center activatable element 904. Selection of the call center activatable element 904 may cause a call to be initiated with a call center so that the individual using the system may have a telephone and or video conference with personnel at the call center. The user interface on the display may also include a tutorial activatable element 906. Selection of the tutorial activatable element causes a tutorial to be displayed to teach the individual about operation of the housing.

The system 900 may include software which allows each user to be coded or assigned to an account and vehicle. Each vehicle can have a verifiably paired digital representation associating the vehicle. This can be verified by the system through recognition of the vehicle from a reader or sensor. The digital or virtual representation can be paired with the vehicle on the immutable storage. When the vehicle arrives at a parking area, the system can retrieve the vehicle information determine of the vehicle or user is properly at the parking spot, such as the user with the reservation.

An inspector activatable element 912, may be activated to cause the inspector functionality to be activated. The inspector functionality may enable an inspector to add inspection notes, provide electronic inspection certificates and the like. The system can provide reports that can be automatically generated from the existing data described herein as well as notes manually added during the construction process. The reports can be generated at predetermined times such as daily or upon completion of specific tasks. The vehicle information can be access at 918 and the account can be access at 920.

As shown in FIG. 10, the exemplary embodiments may be implemented in a decentralized computing environment 1000, that may include distributed systems and cloud computing. One or more systems 1002 that may be in communication with a remote cluster 1006 via a network 1004. The cluster 1006 may store information received from the system 1002 and provide added computational functionality. The network may be a wired network or a wireless network or a combination thereof. The network 1004 may be a secure internet connection extending between the system 1002 and the cluster 1006, such as a virtual private cloud (VPC). The server may be a computing device and can be in communications with the site computer device. The cluster 1006 may include access to storage 1008. The storage 1008 may include a database 1010 in which information regarding a project location is stored in a consistent manner.

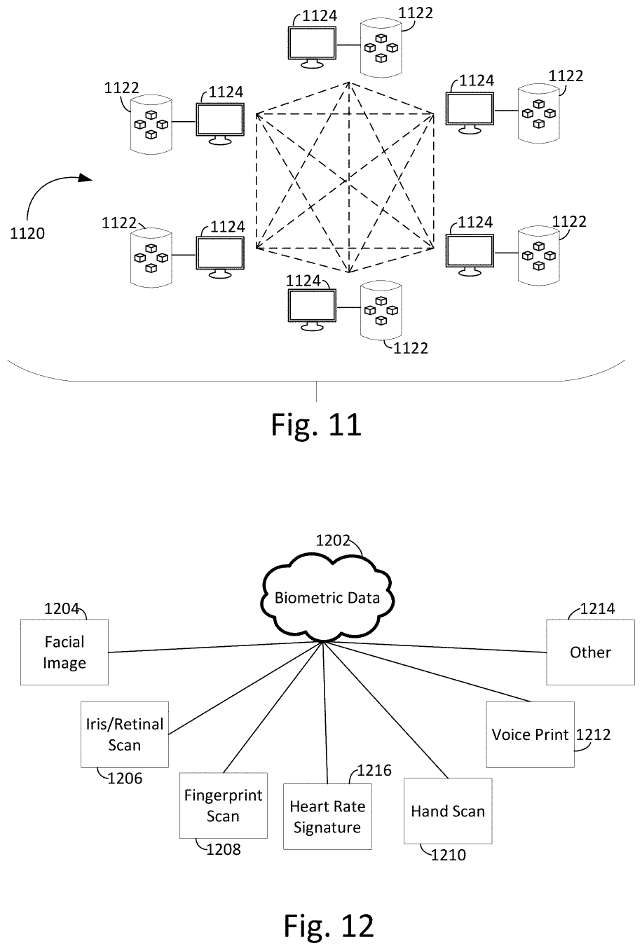

FIG. 11 shows diagram 1100 of an example of a peer-based network where an immutable storage 1102 is broadcast and shared among the nodes 1104. This network may be resident in the VPC cluster 1006 (FIG. 10) or in a network for example. The nodes 1104 may represent computing resources, such as server computer systems or other computing systems, residents at the parties identified in FIG. 11, for example. Each node that has access to a copy of the immutable storage 1102.

The various computer devices, including the server and site computer device (e.g., system, controller, and any combination), can be in communications with immutable storage. The immutable storage can include a distributed ledger, immutable database, block-chain structure, and the like. The communications between the various computer device, including the server and the site computer device and immutable storage can be a global communications network, wide area network, or local area network, delivered to a computer readable medium from one device to another (e.g., USB drive, CD, DVD) and can be wired or wireless.

Referring to FIG. 12, the of biometric data 1202 that may be obtained by biometric-based identification devices at the project location to attempt to identify individuals. Biometric data may include facial recognition 1204, an iris/retinal scan 1206, a fingerprint scan 1208, a hand scan 1210, a voice print 1212 or heart rate signature 1216 or other input or sensor 1214. It should be noted that other types of biometric data may also be used in exemplary embodiments to help identify individuals uniquely. Also, an individual may be required to provide multiple types of biometric data in some instances.

An inspector or enforcement entity may interface with the system and preform steps that may be performed in such an interaction. Initially, the identity of the inspector may be confirmed using the biometric data or manually using the touchscreen on the system. The inspector then performs the inspection of the appropriate portion of the project location. The inspector then accesses the system, such as through the system at. The inspector then may record notes and/or post certificates or notices at the system. Additionally, the inspector may use technology available via the system such as OCR scanner or the like to capture appropriate information the inspector may have written during fulfillment of the reason for being on the site.

Systems at adjacent locations may be used in conjunction with each other. For example, in the event that there are multiple smart indicia on one or more physical objects, the proximity of the indicium to each other can be used to verify the status, disposition and location of the one or more physical objects. In one indicium moves a certain distance from another, it can indicate a change in status that can be associated with an event record and the physical object.

The steps that may be performed by image capture devices, such as still cameras or video cameras, from multiple adjacently situated systems can be used in conjunction. Video feeds or still images may be obtained from the image capture devices from multiple systems. The video feeds or images may then be processed, such as by the cluster described above, using software such as motion detection software, thermal image analysis or other image analysis software to identify activity that may warrant a response. When a motion is detected, it can trigger data capture for that event.

As has been mentioned above, a great deal of information may be collected and stored during the project, process of task for reference during or after the project, process or task is completed. The information obtained during the project from many different sources may be stored on or referenced from immutable storage. The information may be stored on an ongoing fashion, in databases as described below, and may be referenced in an immutable persistent fashion on the storage. This information may help resolve disputes between parties involved on the project or process. For example, suppose the assembler asserts that the wrong items were delivered. Since there is a complete record references on the immutable storage of all deliveries, these records may be accessed to resolve the dispute. Insurance providers may access injury records referenced on the immutable storage to settle or confirm claims. Disputes regarding pay among workers may be resolved by checking the recorded hours on site to determine the appropriate pay for the workers. Inspection records may be accessed to confirm that proper inspections were carried out and passed.

The information referenced in the immutable storage may also be accessed from a computing device of an owner, end user, customer, integrated and the like at. The computing device may be, for example, part of a home maintenance system that manages and controls home systems, such as heating, air conditioning, lighting, an alarm system, or the like. The computing device may be part of a smart home controller and may interface with appliances and other items that are interconnected via a home control network. The computing device may include a document management system for securely storing the transferred information. The computing device may be a facilities management system, or operations system associated with the project location.

Items may be affixed, such as barcodes, QR codes, RFID identification, Bluetooth beacons and/or UHF identification when the items arrive at the supply company. Stickers may be affixed to the items to associate the codes with the items. The items in each package may be scanned to record what items are included in the packages. The packages may be wrapped as needed and a QR code sticker may be affixed to the outside of each package. The QR code for each package is scanned. The process may then generate a material list for each delivery.

Interactions relating to a smart contract for the project or process can be implemented using the system. For example, suppose that the supply company makes a delivery to the project location. Further suppose that the delivery is confirmed by information such as that gathered by the system as discussed above. The lender then releases payment to the supply company. Payments can be made through third party funding, factoring, credit lines, loans, or other financial option to assist with financing and cash flow management.

The payment may be made electronically, such as through crypto currencies, like Bitcoin or Ether, or via a stable coin whose value is pinned to an item like a paper currency or the like. A cryptocurrency is a digital currency built with cryptographic protocols that make transactions secure and difficult to forge. Other Suitable forms of electronic payment includes Automated Clearing House (ACH) payment, Electronic Funds Transfer (EFT), card payments, other types of bank transfers or other types of electronic wallet transfer. In the case where crypto-currency is used, the crypto-currency may be delivered to the digital wallet of the supply company at a specified wallet address or account. The ledger may be updated to show that the contract is complete. Payment requires that the lender has sufficient funding in their digital wallet. If not, the smart contract will not be written on the immutable storage. If there is sufficient funding, payment is made, and the contract is written onto the persistence storage.

There can be a relationship between the smart contracts and the project, process, or event. Initially, a schedule can be received. For example, the assembler can create the project schedule based in part on the design and material requirement record. Based on the project schedule, smart contracts may be constructed that use the immutable storage for contractual arrangements associated with the project or process. The smart contracts are implemented in software and in this case are used to provide electronic payments to parties for activities relating to the project or process using, for example, electronic payments, crypto currencies, fiat currencies and other forms of payments. The smart contracts may specify the conditions required for payment and may specify the amounts of payment. Smart contracts may also play a role with deliveries. Delivery and/or materials information is obtained regarding delivery to the project location for the project or process. The information obtained can include if the materials delivered match the material requirement record, manufacturer, and/or supplier which can be confirmed by multiple parties.

Information can be hashed, and the resulting hash value is referenced on the blockchain-based immutable storage. A smart contract can be provided that uses the immutable storage. A determination is made whether the conditions specified in the smart contract are satisfied. If the conditions are satisfied, electronic payment for the delivery is realized. If the conditions are not satisfied, notice of outstanding issues are sent and the user may attempt to remedy the issues. The process may then repeat beginning with step until the conditions are satisfied.

To pair a material with its digital representation the system captures events at various points of transition of the material. Pairing the physical material with the digital representation can include several elements or components. Included in the pairing process can be the physical observation of the physical material and then associate the physical material with a digital representation so that the physical material is properly associated with the digital representation. This verification provides trust that the digital representation is accurately associated with the physical material as a factor rather than simply trusting that the digital representation is accurate. This system can use manual or automated processes to physically observe the material and associate the material with the digital representation during various events from raw material to final deliverables. Verification can also use the metadata that is associated with the interaction of physical items by individuals and electronics when the item is created, transported, installed, activated, and destroyed. The metadata that can be captured and placed into immutable storage can provide stakeholders an audit trail of history for their physical asset using a verified paired digital representation. A similar process as described herein can be used for pairing a biometric identifier with an individual.

By verifiably pairing the physical asset with a virtual presentation, the risk of unintentional or impermissible rehypothecation can be reduced or eliminated. The paired asset can be verified by multiparty chronological metadata streams that can be associated with a physical location. Because verifications using these streams are chronological, altering the information could require alteration of the metadata prior to and after the altered record. Therefore, the altered record would be inconsistent with the associated records potentially both temporally and geographically and an attempt to alter the record would be discovered. The use of an immutable storage further reduces the risk of alterations of records as well as increasing the verification of information. Further, pairing assets associated with the event, involving the asset, interactions with the asset and the associated metadata provide for a substantiated digital asset, reduce, or eliminate risk and improve capital efficiency. Further, the pairing of assets facilitates commerce by allowing electronic transactions with assurances that the digital representation used in the electronic transaction is paired with the physical asset.

Verification, including verification of an event, can include verifying that the physical material and the digital representation match and can be accomplished in a variation of methods including interaction with identification elements such as a tag, label, plate, and the like, capturing an image of the material, capturing a video of the material, capturing indicia such as a tag physically affixed or otherwise associated with the material, human visual inspection, weight measurements at and between events, capturing the dimensions of the physical object at and between events, and any combination. Identification of an individual performing or otherwise associated with an event can be captured by identification devices (e.g., cards, tags, RF ID. smart dust, beacons, plate, VIN) and biometrics including visual capture (e.g., facial recognition), voice recognition, iris scan, fingerprint, palm print and any combination. Biometrics can include biometric information used accessing the remote computer device.

One verification process can include a comparison of an image of the physical object taken at the first event and the image of the physical object taken at the second event. In one embodiment, the determination if the two images represent the same physical object can be made by comparison the distance between the images. The distance between the images of the two object captures do not have to be identical but can be defined by the “closeness” between the images. In one embodiment, the distance can use the Euclidean distance between the i^{th} and j^{th} physical object. Distance between the p-dimensional vectors can be represented as:

d_{E}(i,j)={square root over ((Σₖ₌₁^{p}(xᵢₖ−xⱼₖ)²))} (1)

or by using the weighted Euclidean distance that can be represented as:

d_{E}(i,j)={square root over ((Σₖ₌₁^{p}wₖ(xᵢₖ−xⱼₖ)²))} (2)

Where d_{E}=distance, i=first image, j=second image, and w=weight between kth measure which can be subject to the following

0<wᵢ<1 and Σᵢ₌₁ⁿ1 (3)

In one embodiment, the verification process can include an individual retrieving the first image of the physical object and comparing the first image with the physical object in proximity of the individual. The individual can review the first event record and the second event record to also make a determination of the physical object has remained the same from the first event to the second event. Information. In one embodiment, multiple individual and computer system can make the comparison. The comparison can also be crowd sourced so that multiple verifications are made from an individual computer system and any combination.

In one embodiment, a repair request can be created at the parking spot and transmitted to the server. The repair request can be associated with the assembly and retrieved by a repair computer system. The repair company can receive a part using the system described herein, perform a repair or replacement action, and capture the event representing the repair or replacement. The repair can also have a preexisting indicium from the use of the system herein and the repair company can capture the event such as by using an indicium. A repair record can be created and stored on the immutable storage.

The system described herein can pair the physical material and/or assembly with a digital representation. Failure to pair the physical material or assembly with the digital representation can negatively impact areas such as regulatory requirements. Regulatory requirements are a set of rules that can specify the standards for a project. Regulatory requirements impact designs, materials, worker's license and experience the project and process. For example, a building code may require that construction materials be installed in accordance with manufacturer's specifications and warranty regulations. Failure to follow the building codes can result in the project not being approved, errors, lack of customer satisfaction, insurance claims, injury, litigation, and other negative ramifications. Tracking, management, and verification of materials to ensure compliance with regulatory requirements and proper installation according to applicable specifications is an important aspect to many projects and processes. Tracking and record keeping during the project or process can be beneficial, as it can be difficult to perform these tasks after project or process completion because the materials can be hidden from view or otherwise inaccessible. For example, electrical wiring in a project or process can be hidden behind walls and ceilings once the project is complete.

Systems at multiple locations may be interconnected using image capture devices, RFID, QR codes, barcodes, biometric scanners, still cameras, video cameras, and the like to identify individuals or machines that are performing verifications during the process. Further, multiple individuals or machines are performing verifications so that there is not a reliance upon any one entity for verifications. The processing of capturing data, including images, from the multiple systems at multiple locations can be used to improve the verification of proper materials and assemblies as well as to pair the physical items with the digital representation.

Verification of processes, inspections, completions and deliveries with adjustments and notifications (manual and automated) with confirmation would ensure increased productivity, especially if accessible in real time at the location. Real time processes and procedures planned with corresponding training and manuals would improve quality control and efficiency. This has been a long felt need in the prior art that has not been satisfied with a controller that is uniquely associated with an asset location.

Automated verification of quantities, quality, and correct product deliveries along with after delivery tracking of materials with accountability is seldom used. Designated delivery areas with geofenced control and tracking of materials once delivered would help prevent loss. Confirmation of products integrated at the asset location provides transparency regarding sourcing, warranties, as well as future reference during the structure and individual product's life of use.

By using the various tags and digital representations, each entity in the process can verify that the physical materials match any record the precedes that entity.

This process can include internal and external individuals and machines for performing inspections (e.g., verifications). For example, the system can receive a set of internal inspection information entered into the system from an internal inspector representing an internal physical inspection of the project, material or assembly. As the items travel, an internal inspector can provide inspection information representing the stages of the project. The system can also receive a set of external inspection information from an external inspector and an external inspection computer device representing a third-party physical inspection of the project at predetermined stages of the project. Based upon the internal inspection, external inspection or both, an inspection record can be created and stored on the immutable storage.

The verified pairing described herein can also be used to verifiable pair physical assets with installation instructions, storage instructions, warranties, ownership, service, maintenance, and any combination thereof.

The system can also facilitate the use of digital wallets. The information that is contained on the digital wallet can be paired with a physical object so that transactions associated with the physical object can be conducted with verification that the digital representation in the digital wallet represents the physical object, whether the physical object is fungible or unique.

1. A computerized system for dynamic allocation of a spatial area for vehicle parking comprising:
a server having a computer readable medium and a set of computer readable instructions;
an immutable storage system in communications with the server and having a user record wherein the user record is a digital representation of a user having biometric data associated with the user;
a digital geofence area record stored on the immutable storage system representing a physical parking spot disposed in a physical parking area wherein the geofence area record is verifiably paired with the physical parking area according to a data capture of the physical parking spot and parking metadata associating the physical parking spot with a parking spot digital representation using GPS information;
a user database wherein the user record includes an association with a financial account;
a remote computer device;
a camera included in the remote computer device;
a biometric reader included in the remote computer device taken from the group consisting of a facial recognition scanner, an iris scanner, a retinal scan, a fingerprint scanner, a hand scanner, a voice print recorder, a heart rate signature recorder and any combination thereof;
wherein the remote computer device is in communications with the server, user database and immutable storage system and configured to:
capture a current location information and a current visual information of a user vehicle physically positioned in the physical parking spot;
transmit the current location information captured by the remote computer device to the server,
transmit the current visual information captured by the remote computer device to the server,
retrieve the geofence area record from the immutable storage system;
associate the current location information with the physical parking spot according to a comparison of the current location information with the geofence area record,
determine a vehicle identification according to the current visual information,
associate the vehicle identification with the user record,
capture a current biometric data using the biometric reader; and,
debit of the financial account associated with the user according to a period of time that the vehicle is at the physical parking spot and a comparison with the biometric data in the user record and the current biometric data.

2. (canceled)

3. The computerized system of claim 1 wherein the set of computer readable instructions are configured to effectuate the debit of the financial account according to a set of transaction rules stored on the immutable storage system.

4. The computerized system of claim 1 wherein the current location information includes current location metadata and the set of computer readable instructions are configured for verifying a location of the vehicle according to a comparison of the current location metadata with a geofence area metadata.

5. The computerized system of claim 1 wherein the current visual information includes a current visual information metadata and the set of computer readable instructions are configured for verifying a location of the vehicle according to a comparison of the current visual information metadata with a geofence area metadata.

6. The computerized system of claim 1 wherein the geofence area record includes an availability data and the set of computer readable instructions are configured for determining a time that the location information is captured and transmitting a vacancy information to the remote computer device.

7. The computerized system of claim 1 wherein the set of computer readable instructions are configured for transmitting a vacancy information to the remote computer device according to a determination that a parking spot will be available.

8. The computerized system of claim 1 wherein the set of computer readable instructions are configured for receiving an enforcement event including metadata having time, location and biometrics of an enforcer and transmitting the enforcement event to an enforcement entity.

9. The computerized system of claim 1 wherein the set of computer readable instructions are configured for transmitting an enforcement action in response to an enforcement event.

10. The computerized system of claim 9 wherein the enforcement action includes a first image of a vehicle prior an enforcement action and a second image of the vehicle post the enforcement action.

11. The computerized system of claim 9 wherein the set of computer readable instructions are configured for receiving a remedial action in response to satisfaction of the enforcement event.

12. The computerized system of claim 1 wherein the geofence area record includes an availability data and the set of computer readable instructions are configured to transmit an expiration notification to the remote computer device representing that a vehicle authorization to occupying the physical parking spot has expired.

13. The computerized system of claim 12 wherein the debit of the financial account is a first debit of the financial account and the set of computer readable instructions are configured for actuating a second debit of the financial account representing that a vehicle has occupied the physical parking spot past allotted time.

14. The computerized system of claim 1 wherein the set of computer readable instructions are configured for receiving the visual information and transmitting an expiration notification to an enforcement computer system according to a determination that a vehicle associated with the visual information is not authorized to park in a parking spot.

15. The computerized system of claim 1 wherein the set of computer readable instructions are configured for transmitting an expiration information to the remote computer device.

16. The computerized system of claim 1 wherein the set of computer readable instructions are configured for transmitting a first amount of the debit to a first entity and transmitting a second amount of the debit to a second entity.

17. The computerized system of claim 16 wherein the first entity is a management company, and the second entity is a parking lot owner.

18. The computerized system of claim 1 wherein the set of computer readable instructions are configured for receiving a vehicle location information, transitioning a status included in the geofence area record from occupied to available and actuating the debit of the financial account according to detecting a vehicle leaving the physical parking spot.

19. The computerized system of claim 1 wherein the set of computer readable instructions are configured for receiving a parking spot reservation and transitioning a status included in the geofence area record from available to reserved.

20. A computerized system for dynamic allocation a spatial area for vehicle parking comprising:
a server having a computer readable medium and a set of computer readable instructions;
a physical parking spot adapted to receive a vehicle;
a geofence area record stored on an immutable storage system representing the physical parking spot according to an association of a parking spot metadata with the physical parking spot when the geofence area record is created and in communications with the server;
a user record stored on the immutable storage system digitally representing a user wherein the user record includes a biometric information associated with the user;
a remote computer device;
a biometric reader included in the remote computer device wherein the remote computer device is in communications with the server and immutable storage system and configured to:
capture current biometric data using the biometric reader;
retrieve the user record from the immutable storage system;
create a user authorization record according to a comparison of the current biometric data and the biometric information included in the user record;
capture a current location information representing a vehicle location of a vehicle disposed on the parking spot;
actuate a debit of a financial account associated with the user upon receiving a reservation request,
transition a status included in the geofence area record from available to reserved,
retrieve the geofence area record from the immutable storage system;
associate the current location information with the physical parking spot according to a comparison of the current location information with the geofence area record and the reservation request, and,
transition the status included in the geofence area record from reserved to occupied according to the comparison of the current location information with the geofence area record.

21. (canceled)

22. The computerized system of claim 20 wherein the set of computer readable instructions are configured to effectuate the debit of the financial account according to a set of transaction rules stored on the immutable storage.

23. The computerized system of claim 20 wherein the set of computer readable instructions are configured for crediting the financial account according to a violation information received by the remote computer device.

24. The computerized system of claim 20 including a violation system wherein the violation system is configured for debiting the financial account of the user according to a determination that the physical parking spot is occupied by a violating object.

25. The computerized system of claim 20 wherein the remote computing device is taken from the group consisting of a vehicle tracking systems, an entertainment system, a smart phone, a telematics devices, an event data recorder and any combination.

26. A computerized system for dynamic allocation of a spatial area for vehicle parking comprising:
a server having a computer readable medium and a set of computer readable instructions;
a geofence area record stored on the computer readable medium representing a physical parking spot according to a GPS information and a comparison of the physical parking spot with a parking spot metadata captured when the geofence area record is created and overlayed with the GPS information;
a remote computer device;
a camera included in the remote computer device;
a biometric reader included in the remote computer device;
wherein the remote computer device is in communications with the server and an immutable storage system and configured to:
capture a current location information and a current visual information using the camera;
transmit a status of the physical parking spot to the server,
retrieve the geofence area record from the server;
associate the current location information with the physical parking spot according to a comparison of the current location information with the geofence area record,
associate a vehicle with a user account according to the current visual information, and,
debit a financial account associated with the vehicle according to a determination that biometric data captured at the physical parking spot matches a user record wherein the user record include previously captured biometric data.

27. The computerized system of claim 26 wherein set of computer readable instructions are configured to transmit a violation information to an enforcement computer system according to a determination that the vehicle is disposed in the physical parking spot past an authorized period of time.

28. The computerized system of claim 26 wherein the set of computer readable instructions are configured for aggregating a plurality of geofence area records and transmitting a full lot information to the remote computer device according to a determination that each physical parking lot is occupied or reserved.

29. (canceled)

30. The computerized system of claim 26 wherein the set of computer readable instructions are configured to effectuate a debit of the financial account according to a set of transaction rules stored on the computer readable medium.
